(19) United States
(12) Patent Application Publication
(10) Pub. No.: US 2007/0251103 A1
(43) Pub. Date: Nov. 1, 2007

(54) Baby spoon

(75) Inventor: Idus L. Rhodes III, Maplewood, MO (US)

Correspondence Address: SENNIGER POWERS, ONE METROPOLITAN SQUARE, 16TH FLOOR, ST LOUIS, MO, 63102, US

(73) Assignee: Handi-Craft Company, St. Louis, MO (US)

(21) Appl. No.: 11/417,475

(22) Filed: May 1, 2006

(51) Int. Cl. A47J 43/28

(52) U.S. Cl. 30/324

(57) ABSTRACT

A baby spoon has a handle and a bowl connected to the handle. The bowl has laterally spaced side edges, a back edge extending generally transversely between the side edges, and front edge longitudinally spaced from the back edge and extending transversely between the side edges of the bowl. The front edge includes a forward most extent of the bowl and has a smallest radius of curvature of not less than about 0.75 inches. The side edges define a bowl width including a maximum bowl width. The bowl width decreases from the maximum forward to the front edge of the bowl. The longitudinal distance between the maximum bowl width and the forward most extent of the bowl is no more than about 0.75 inches. In another embodiment, the maximum width of the bowl is nearer to the front edge of the bowl than to the back edge of the bowl.

### FIELD OF INVENTION

The present invention relates generally to spoons, and more particularly to small spoons used to feed infants and toddlers.

### BACKGROUND

Spoon feeding infants and toddlers (broadly, babies) has always presented special challenges in that babies have to learn how to take food into their mouth and swallow it. Until they become proficient at this, the food that is spoon fed to them, which is usually pureed or otherwise softened, often winds up all over their faces, particularly near their mouths and chins. Specialized baby spoons, which are often simply smaller versions of the spoons designed for use by adults, have long been available, but they have not solved this problem. It can take two or three tries to get an entire spoonful of baby food into the baby's mouth even while using a smaller baby spoon. Thus, people often wind up using the baby spoon to scrape and gather food from the baby's face to contain the mess and again offer the food to the baby.

Baby food is often sold in small jars, small plastic tubs or other small containers, making it sometimes difficult to get the last of the food out of a container using a conventional baby spoon. For example, because of the rounded bowl shape and generally straight configured handle of the conventional spoon, it can be difficult to position a baby spoon into the bottom edge of the container to gather the last of the food from the container into the spoon. Even when it is possible to position the end of a spoon at the bottom edge of the inside of the container, the bowl of the spoon may still have a shape that makes it difficult to gather food from the bottom edge of the container into the spoon. The result can often be that a significant amount of baby food is discarded as residue after the baby food container has been emptied to the extent that is feasible using a conventional spoon.

Thus, there is a need for an improved baby spoon that is conducive to spoon feeding babies, and in particular a baby spoon that facilitates gathering food from a baby's face into the spoon and a baby spoon that makes it more convenient to gather all the food in a baby food container into the spoon.

### SUMMARY OF INVENTION

One embodiment of a baby spoon of the present invention comprises an elongate handle and a bowl connected to the handle. The bowl has laterally spaced side edges, a back edge extending generally transversely between the side edges, and front edge longitudinally spaced from the back edge and extending transversely between the side edges of the bowl. The front edge of the bowl includes a forward most extent of the bowl. The front edge of the bowl also has a smallest radius of curvature of not less than about 0.75 inches. The spacing between the side edges defines a width of the bowl including a maximum width of the bowl. The maximum width of the bowl is spaced longitudinally from the forward most extent of the bowl a distance of no more than about 0.75 inches. The width of the bowl decreases from the maximum width forward to the front edge of the bowl.

In another aspect of the invention a baby spoon comprises an elongate handle and a bowl connected to the handle. The bowl has laterally spaced side edges, a back edge extending generally transversely between the side edges, and a front edge longitudinally spaced from the back edge and extending transversely between the side edges of the bowl. The front edge of the bowl includes a forward most extent of the bowl. The front edge of the bowl further has a smallest radius of curvature of not less than about 0.75 inches. The bowl has a length from the back edge to the front edge of the bowl of no more than about two inches. The spacing between the side edges defines a width of the bowl, including a maximum width of the bowl. The width of the bowl decreases from the maximum width forward to the front edge of the bowl and rearward to the back edge of the bowl. The maximum width of the bowl is nearer to the front edge of the bowl than to the back edge of the bowl.

### BRIEF DESCRIPTION OF THE DRAWINGS

FIG. 1 is a perspective view of one embodiment of a baby spoon of the present invention;

FIG. 2 is a side elevation of the baby spoon shown in FIG. 1;

FIG. 3 is a top plan view of the baby spoon shown in FIGS. 1 and 2;

FIG. 4 is a cross section of the baby spoon shown in FIGS. 1-3 taken in a plane including line 4- -4 on FIG. 3;

FIG. 5 is a cross section of the baby spoon shown in FIGS. 1-4 taken in a plane including line 5- -5 on FIG. 3;

FIGS. 6-8 illustrate the baby spoon of FIG. 1 positioned variously within a baby food container;

FIG. 9 illustrates the baby spoon of FIG. 1 in another baby food container;

FIG. 10 illustrates the baby spoon of FIG. 1 being used in one orientation to collect food off of a baby's face; and

FIG. 11 illustrates the baby spoon of FIG. 1 being used in another orientation to collect food off of a baby's face.

Corresponding reference characters indicate corresponding parts throughout the drawings.

### DETAILED DESCRIPTION

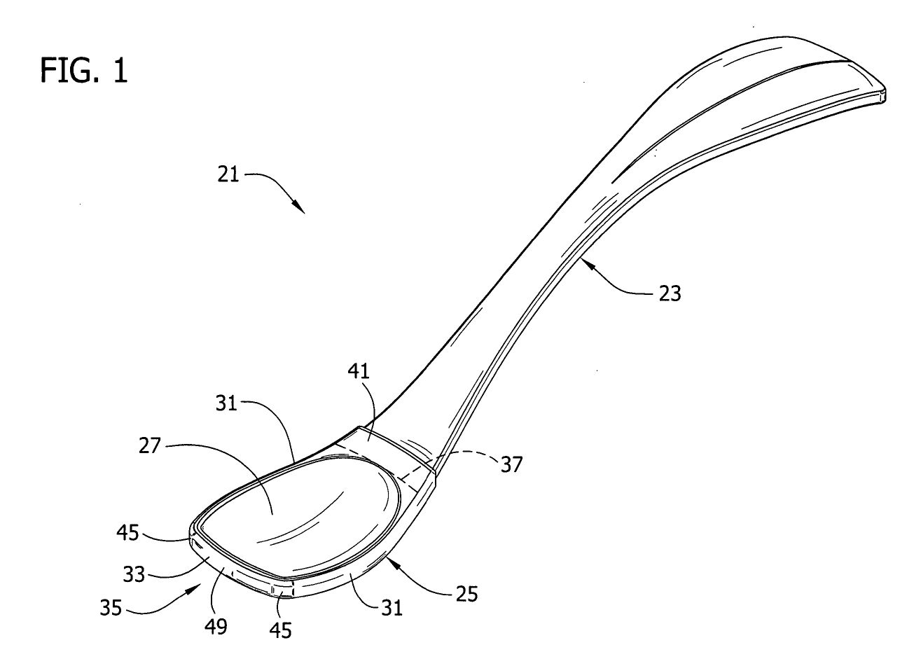

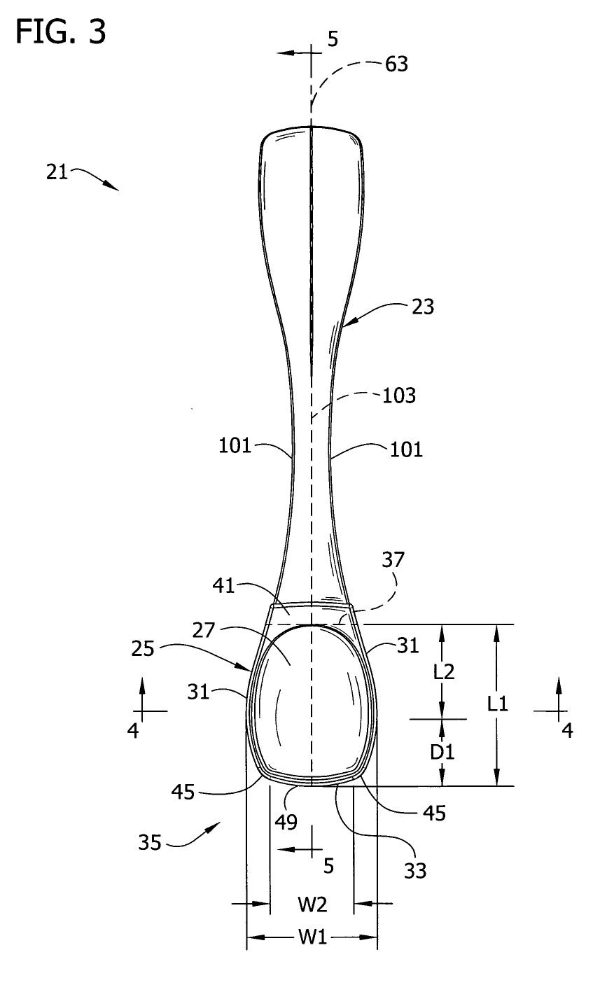

With reference to the drawings, and in particular to FIG. 1, one embodiment of a baby spoon is generally indicated at 21 and comprises an elongate handle 23 and a bowl, generally designated at 25, connected to the handle and having a concavity 27 formed therein to hold baby food during use. As best illustrated in FIG. 3, the bowl 25 suitably comprises transversely spaced, longitudinally extending side edges 31, a front edge 33 extending transversely between the side edges at a front end 35 of the spoon, and a back edge 37 (indicated by the dashed line in FIG. 3) extending transversely between the side edges in longitudinally spaced relationship with the front edge of the spoon. As used herein, the “back edge” of the bowl 25 refers to an actual or imaginary (as illustrated) line extending from one side edge to the other at the rearward most extent of the concavity 27. That is, if the spoon 21 were filled with liquid to full capacity of the bowl 25, the back edge 37 of the bowl would extend transversely between the side edges 31 of the bowl at the rearward most extent of the liquid in the bowl. Thus, where the handle 23 and the bowl 25 are configured to have a smooth transition from the handle into the bowl as in the illustrated embodiment, the bowl still has what is referred to herein as a back edge 37.

In the illustrated embodiment, the elongate handle 23 is connected at one longitudinal end 41 to the back edge 37 of the bowl 25 and extends longitudinally therefrom.

However, it is understood that the handle need not be connected to the back edge of the bowl, nor must it extend longitudinally from the bowl 25, to remain within the scope of this invention.

In one embodiment, the bowl 25 of the spoon may be coated with an elastomeric coating. The elastomeric coating may resiliently yield to a surface (e.g., a baby's face or the inside of a baby food container), facilitating line contact between the bowl 25 and the surface. This may make it easier to use the bowl 25 of the spoon 21 as a squeegee to wipe food off the baby, from the inside of a baby food container, and/or from other surfaces. The elastomeric coating may also make the spoon 21 more comfortable for the baby. Suitable elastomeric coatings include thermoplastic elastomer (TPE), PVC, Silicone, Latex, etc. It is understood, however, that an elastomeric coating is not required and that uncoated spoons are within the scope of the invention. It is also understood that the edge of any coating on the bowl does not necessarily coincide with the back edge 37 of the bowl.

In one particularly suitable embodiment, the front edge 33 of the bowl 25, extending transversely between the side edges 31 of the bowl, is substantially straight and more suitably the front edge has a smallest radius of curvature that is not less than about 0.75 inches. The term “smallest radius of curvature” means the radius of curvature of any segment along the front edge 33 of the bowl. More suitably the smallest radius of curvature of the front edge 33 of the bowl 25 is not less than about 1.00 inch, even more suitably it is not less than about 1.25 inches, still more suitably it is not less than about 1.35 inches. In additional embodiments the smallest radius of curvature of the front edge 33 of the bowl is suitably not less than about 1.75 inches, more suitably it is not less than about 2.00 inches, even more suitably it is not less than about 2.5 inches and may suitably be not less than about 3.00 inches. In still other embodiments the smallest radius of curvature of the front edge 33 of the bowl 25 may be greater than 3.00 inches and may be substantially greater than 3.00 inches such as to approach an infinite radius of curvature (i.e., a straight line). It is also contemplated that the front edge 33 of the bowl 25 may extend transversely between the side edges 31 of the bowl 25 along a straight line without departing from the scope of this invention.

The longitudinally extending side edges 31 of the bowl 25 are suitably arcuate along their entire length from the back edge 37 to the front edge 33 of the bowl, with a smallest radius of curvature of not less than about 0.75 inches, more suitably not less than about 1.25 inches, and even more suitably not less than about 1.50 inches. In the illustrated embodiment, the side edges 31 of the bowl 25 and the front edge 33 of the bowl converge, i.e., intersect, at a pair of generally rounded comers 45 that are transversely spaced from each other. The term “corner” is thus used herein to refer to the place at which two converging lines meet. It is understood that such a corner need not define an angle of 90 degrees but rather it may be any angle (e.g., an angle greater than 90 degrees and less than 180 degrees) that may be delineated by the convergence of a side edge 31 with the front edge 33 of the bowl 25. It is also contemplated that the bowl may be configured so as not to have clearly defined corners and remain within the scope of this invention.

The side edges 31 of the bowl 25 thus define a width of the bowl 25 along its length from the back edge 37 to the front edge 33 of the bowl. With particular reference to FIG. 3, the bowl 25 has a maximum width W1 intermediate the back edge 37 and the front edge 33 of the bowl. In one suitable embodiment, the width of the bowl 25 tapers inward or otherwise decreases as the side edges 31 extend forward from the maximum width W1 of the bowl to the front edge 33 of the bowl. In another suitable embodiment the width of the bowl 25 also tapers inward or otherwise decreases as the side edges 31 extend rearward from the maximum width W1 of the bowl to the back edge 37 of the bowl. In one particularly suitable embodiment, the bowl 25 is configured so that the maximum width W1 of the bowl is spaced longitudinally from a forward most extent 49 of the bowl a distance D1 (shown in FIG. 3) of not more than about 0.8 inches, more suitably not more than about 0.7 inches, and even more suitably not more than about 0.6 inches.

As used herein the “forward most extent” 49 of the bowl 25 refers to the apex of the front edge 33 of the bowl where the front edge is arcuate, as in the illustrated embodiment, or the entire front edge where the front edge is straight. It is possible that the front edge of the bowl could curve slightly inward (in which case the forward most extent of the bowl would be at one or both of the sides of the front edge of the bowl) or have other curvatures (e.g., a curvature having one or more inflection points, in which case the forward most extent of the bowl would be the one or more points on the front edge of the bowl spaced farthest from the back edge of the bowl), without departing from the scope of the invention. Likewise, it is possible that the front edge of the bowl may be substantially straight but angled with respect to an axis extending longitudinally between the front and back ends of the spoon (in which case the forward most extent of the spoon is at the side of the front edge of the bowl that is farther from the back edge of the bowl) without departing from the scope of the invention.

For reference purposes, in one embodiment the length L1 (shown in FIG. 3) of the bowl 25, i.e., from the back edge 37 of the bowl to the forward most extent 49 of the bowl along the front edge 33 thereof, is suitably not more than about 2.5 inches, more suitably not more than 2.25 inches, and even more suitably not more than about 2.00 inches. In another embodiment the length L1 of the bowl 25 is not more than about 1.75 inches. In yet another embodiment the length L1 of the bowl 25 is not more than about 1.50 inches. The maximum width W1 of the bowl 25 in one embodiment is suitably not more than about 1.5 inches. In another embodiment the maximum width W1 of the bowl 25 is not more than about 1.25 inches. In yet another embodiment the maximum width W1 of the bowl 25 is not more than about 1.0 inch.

In another suitable embodiment, the longitudinal distance D1 between the maximum width W1 of the bowl 25 and the forward most extent 49 of the bowl is no more than about ⅔ of the longitudinal distance L2 (shown in FIG. 3) between the maximum width of the bowl and the back edge 37 of the bowl. In yet another suitable embodiment, the front edge 33 of the bowl 25 has a width W2 that is less than the maximum width W1 of the bowl, with a ratio of the width of the front edge of the bowl to the maximum width of the bowl being at least about 0.75, more suitably in the range of about 0.75 to about 0.95, and even more suitably in the range of about 0.75 to about 0.85.

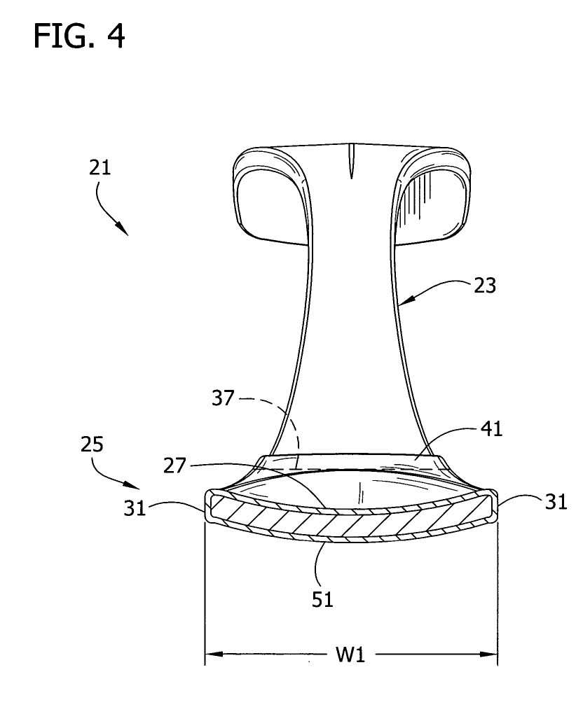

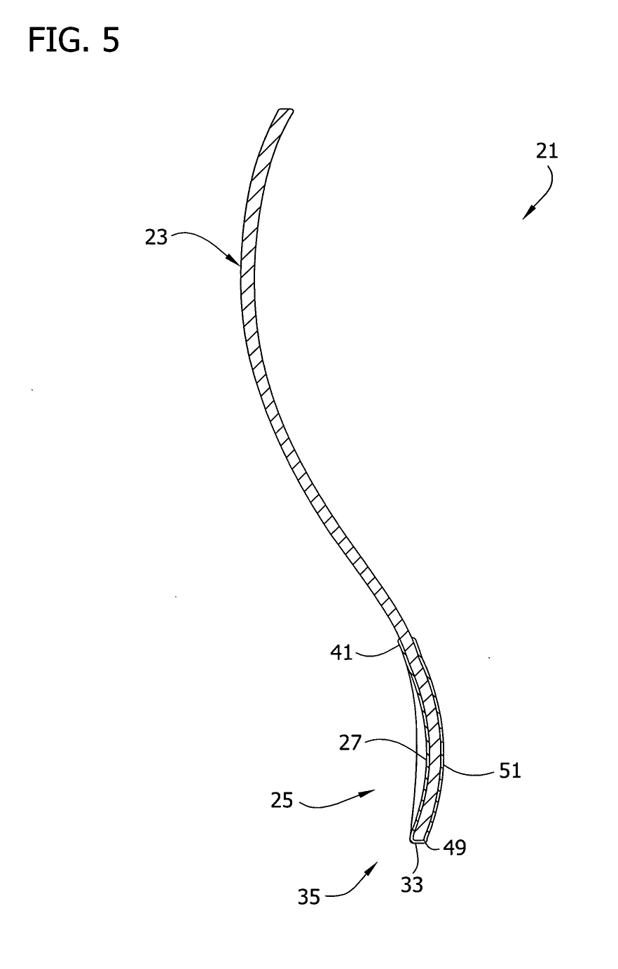

As best seen if FIGS. 4 and 5, the concavity 27 of the bowl 25 extends from generally adjacent the back edge 37 of the bowl to generally adjacent the front edge 33 of the bowl. In one particularly suitable embodiment, the concavity 27 of the bowl 25 is generally arcuate continuously along the entire length of the concavity. Likewise, the concavity 27 extends transversely from generally adjacent to one side edge 31 of the bowl 25 to generally adjacent the opposite side edge of the bowl and is suitably arcuate continuously across the width of the concavity. As used herein, the “concavity” 27 of the bowl 25 refers to the concave portion of the upper or inner surface of the bowl, it being understood that the convex lower or outer surface 51 of the bowl may be shaped differently from the upper or inner surface of the concave portion of the bowl. It is also understood that the curvature of the concavity 27 may be different along its length than along its width without departing from the scope of the invention.

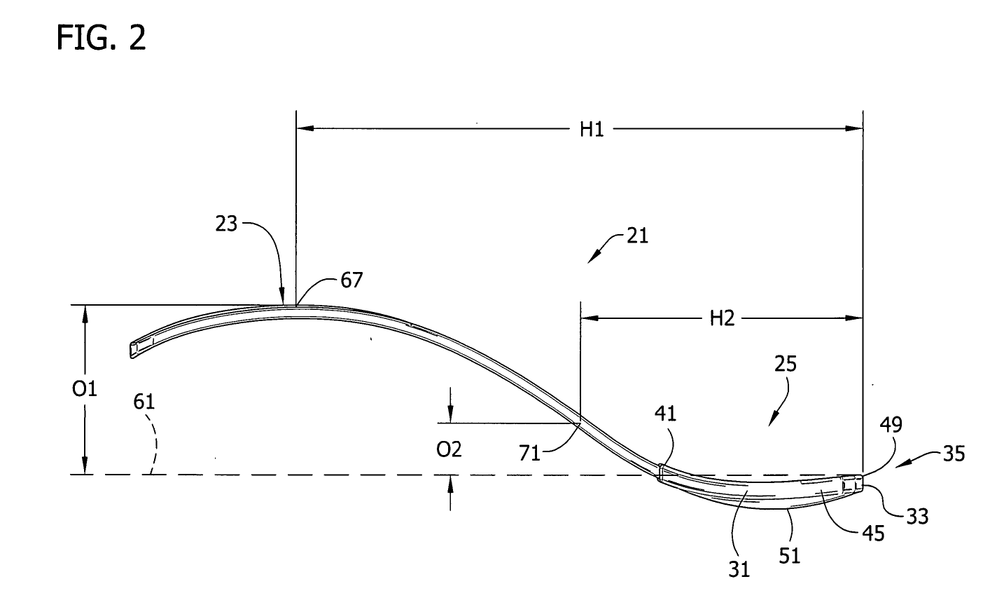

The handle 23 of the illustrated embodiment is curved (as best shown in FIG. 2) so that at least a portion of the handle is offset from a plane 61 that includes the front and back edges 33, 37 of the bowl 25. As shown in FIG. 3, however, the handle 23 and bowl 25 share a common longitudinally extending axial centerline plane 63. In other words, the centerline 63 of the handle 23 of the illustrated embodiment has substantially no curvature in the transverse direction (the transverse direction being defined so that the side edges 31 of the bowl 25 are spaced apart in the transverse direction). In one suitable embodiment, at least a portion 67 of the handle 23 is offset from the plane 61 defined by the front 31 and back edges 37 of the bowl 25 a distance O1 of at least about 0.75 inches, more suitably at least about 1.00 inch, even more suitably at least about 1.25 inches. A portion of the handle 67 at which the offset is at its maximum along the handle is suitably spaced longitudinally from the forward most extent of the bowl a distance H1 in the range of about 3 inches to about 4 inches, and more suitably in the range of about 4 inches to about 5 inches.

In the illustrated embodiment, the handle 23 is particularly configured to have an inflection point 71 between the back edge 37 of the bowl and the portion 67 of the handle 23 having the maximum offset from the bowl 25. Forward of the inflection point 71 on the handle 23, the rate at which the curvature of the handle results in an increase in the offset from the bowl 25 per unit of distance that the handle is spaced from the bowl is increasing. Rearward of the inflection point 71 on the handle 23, the rate at which the curvature of the handle results in a decrease in the offset from the bowl per unit of distance the handle is spaced from the bowl is increasing. The inflection point 71 is suitably spaced from the forward most extent of the bowl 49 a distance H2 in the range of about 1.75 to about 2.75 inches, and more suitably in the range of about 2.0 to about 2.5 inches. The handle 23 is suitably offset from the plane 61 defined by the front and back edges 33, 37 of the bowl 25 at the inflection point 71 a distance O2 in the range of about 0.10 inches to about 1.00 inch, and more suitably in the range of about 0.25 inches to about 0.50 inches.

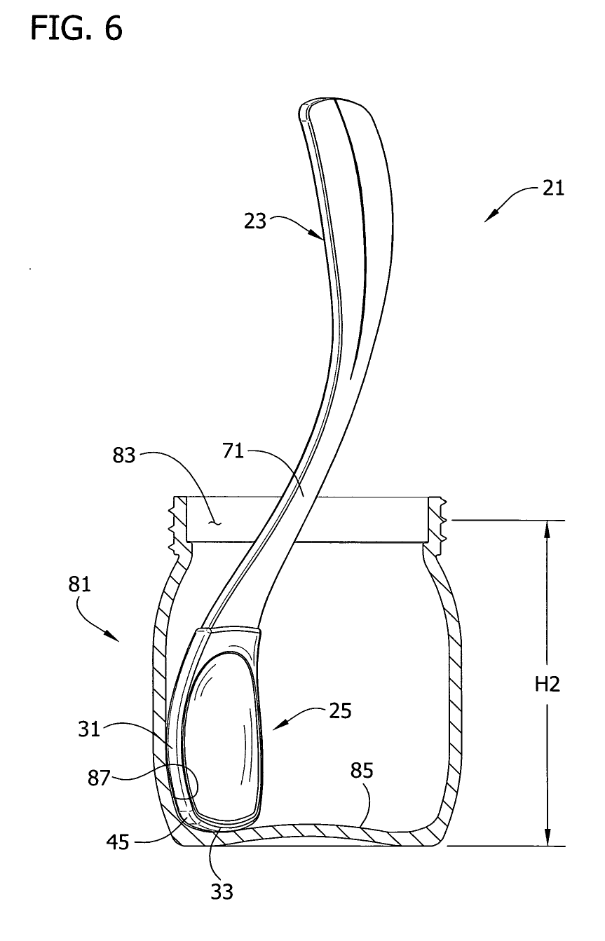

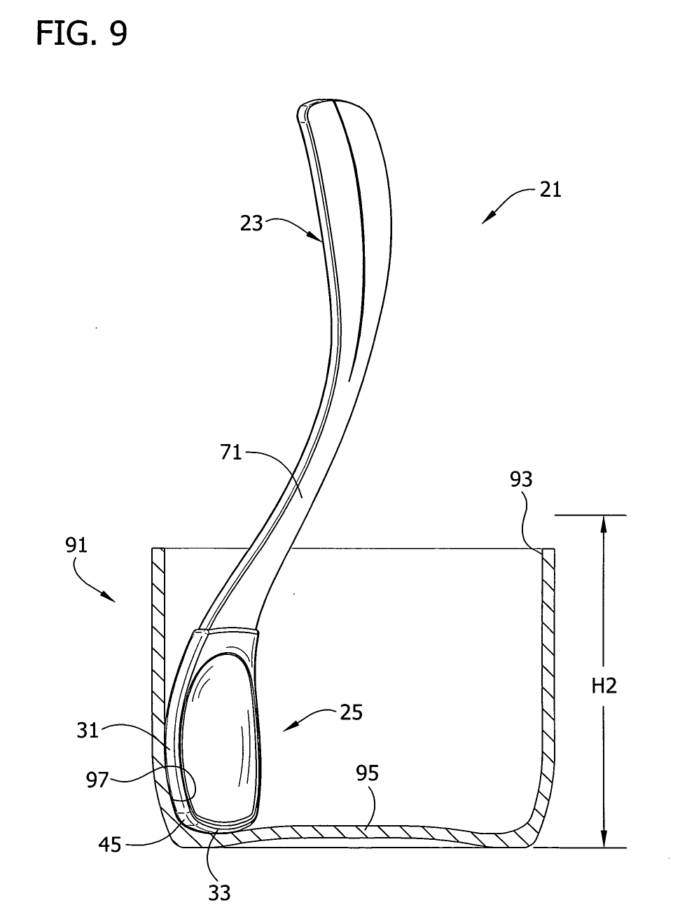

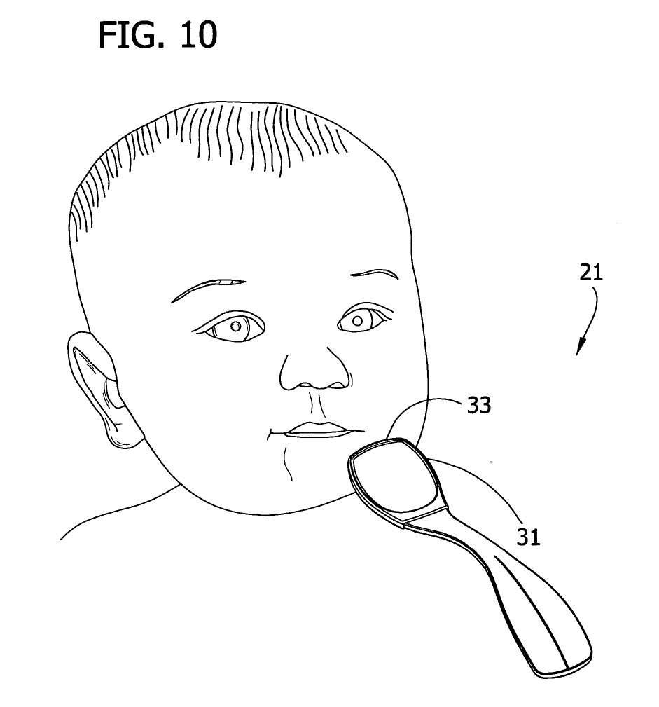

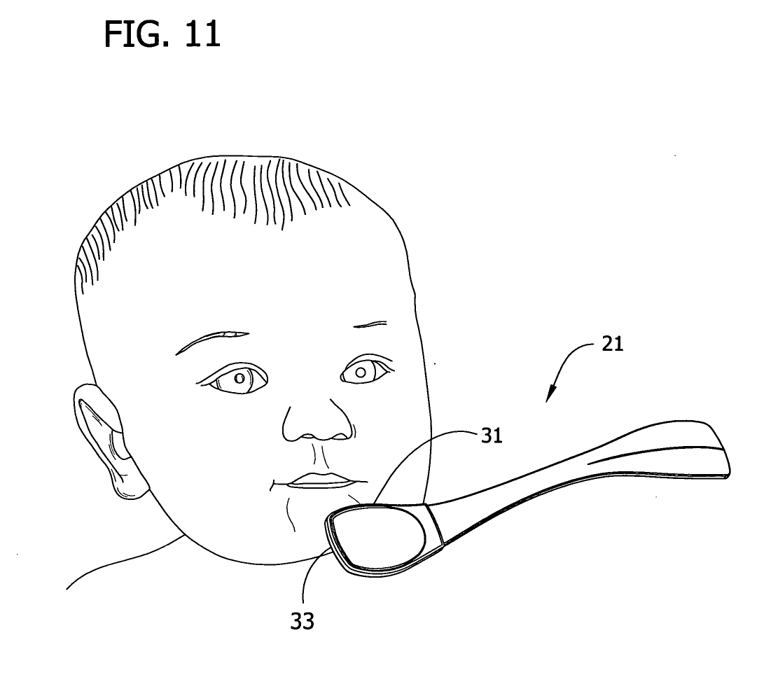

FIGS. 6-9 show the spoon 21 in relation to two different baby food containers, FIGS. 6-8 showing a widely used glass jar 81 and FIG. 9 showing a plastic tub 91 that has recently become available commercially. Those skilled in the art will recognize from the ranges provided above that distance H2 between the inflection point 71 and the forward most extent 49 of the bowl 25 generally corresponds to the distance between the opening 83 of the jar 81 and the bottom 85 of the jar as well as the distance between the opening 93 of the tub and the bottom 95 of the tub. Accordingly, when the spoon 21 is inserted all the way into the jar 81 of baby food (e.g., so that the front edge 33 of the bowl 25 is in contact with the bottom 85 of the jar as shown in FIG. 6), the curvature of the part of the handle 23 that is inside the jar 81 is shaped to increase the amount of offset in the handle until the handle is at the opening 83 of the jar. This facilitates passage of the handle 23 through the opening 83 (preferably with ample clearance so that any food residue that may line the opening does not get on the handle) while the bowl 25 is adjacent a side 87 of the jar 81 (e.g., to gather the last of the food into the bowl). Rearward of the inflection point 71, the amount of offset is not critical for passage of the handle through the opening 83 of the jar 81. However, reducing the rate at which the offset of the handle 23 increases rearward of the inflection point 71, providing a portion 67 of the handle having a maximum offset from the bowl 25, and continuing the curvature of the handle rearward of the maximum offset so that the end of the handle opposite the bowl 25 is offset from the plane 61 of the front and back edges 33, 37 of the bowl 25 makes it convenient for users to hold the handle and to manipulate the bowl. For example, a user can change the orientation of the bowl 25 without changing the orientation of his or her hand by adjusting where he or she grips the handle 23. As shown in FIG. 6, it may possible to orient the spoon 21 so that the front edge 33 of the bowl 25, of one of the comers 45 of the bowl, and one of the sides 31 of the bowl generally conform to the shape of the container at the between the side 87 and bottom 85 thereof.

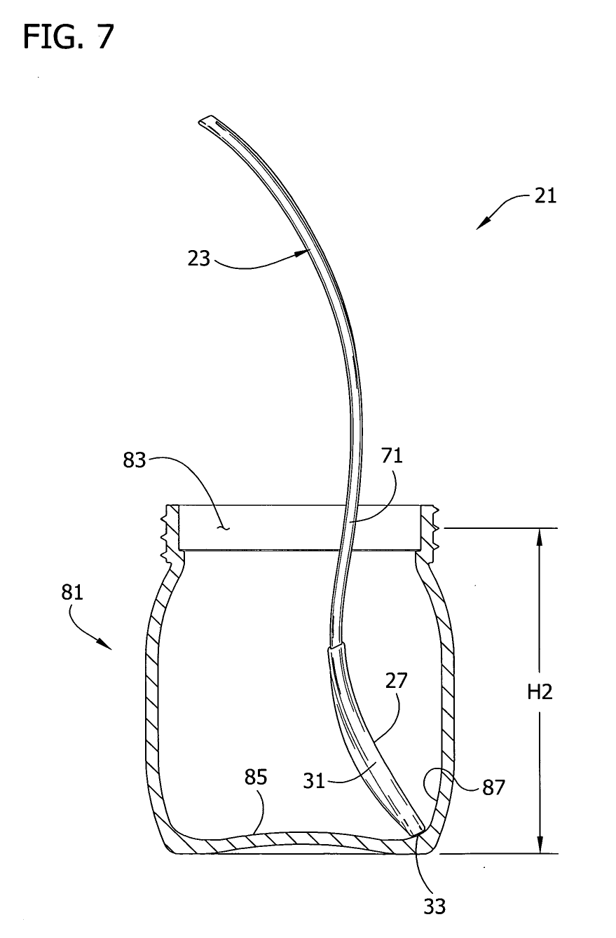

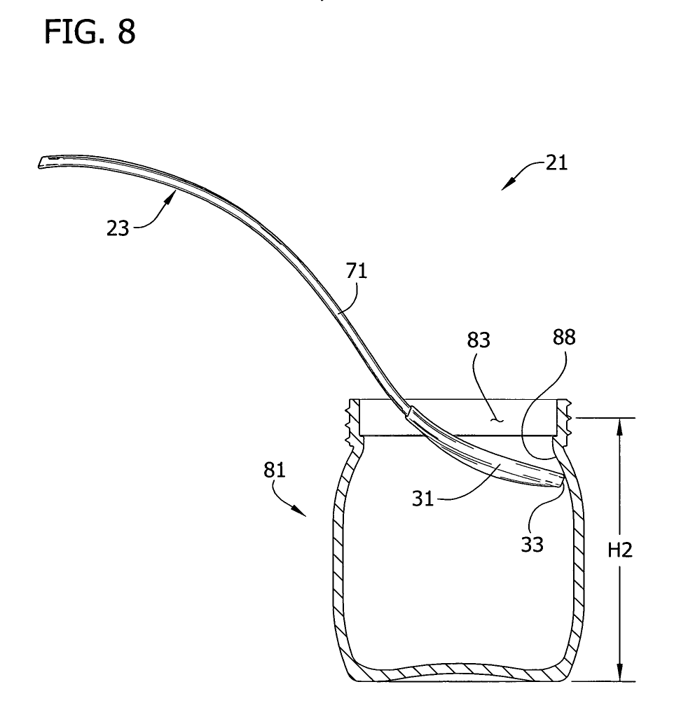

FIG. 7 shows the spoon 21 oriented so the front edge 33 is at the bottom inside edge of the container 81 and the concave surface 27 thereof faces generally toward the adjacent sidewall 87. The front edge 33 of the spoon 21 can be used to move any food on the bottom of the jar 81 to this location. From here, the front edge 33 of the bowl can be moved up along the inside of the sidewall 87 to gather food from the container. By varying the orientation of the spoon 21 using the curved handle 23 as the front edge 33 of the bowl 25 is moved up the sidewall, the slightly curved front edge 33 and/or elastomeric coating of the embodiment shown in the drawings may be made to at least generally conform to the curvature of the sidewall 87. In this regard, the bowl 25 of the spoon 21 can be used like a squeegee to wipe food from the sidewall 87. Further, the shape of the handle 23 allows the bowl 25 to remain in continuous contact with the sidewall 87 as it is moved up along the sidewall to a difficult-to-reach inward curving portion 88 of the sidewall (as shown in FIG. 8) near the opening 83. The ability to orient the spoon 21 so the front edge 33 of the bowl contacts an inward curving portion 88 of the sidewall 87 near the opening 83 also facilitates removal of food from the difficult-to-reach inward curving portion of sidewall independent of use of the spoon to squeegee the sidewall.

The plastic tub 91 shown in FIG. 9 is slightly shorter than the jar 81, which results in the inflection point 71 being located outside the container 91 when the spoon 21 is inserted in the opening 93 (as shown in FIG. 9) so that the front edge 33 of the bowl 25 is in contact with the bottom 95 of the tub and one of the side edges 31 of the bowl is in contact with a side 97 of the tub. Nevertheless, similar advantages are obtained by use of the spoon 21 in that the offset of the handle 23 at the opening 93 is sufficient to maintain ample clearance between the handle and tub at the opening. Likewise, the curvature of the handle makes it easy for the user to manipulate the bowl (e.g., by adjusting where he or she grips the handle). Moreover, it is possible to orient the spoon 21 so the front edge 33 of the bowl 25, one of the comers 45, and one of the sides 31 generally conform to the shape of the container between the bottom 95 and sidewall 97, as shown in FIG. 9. Similar advantages may also be obtained if the spoon 21 is used with a container (not shown) that is slightly taller than the jar 81.

The sides 101 of the handle 23 of the illustrated embodiment curve toward each other as they move away from the bowl 25 to a part of the handle 103 having a local minimum in width. Rearward of that part of the handle 103, the sides of the handle move away from each other, thereby giving the handle an hourglass shape.

The spoon 21 is generally used in much the same manner as prior art baby spoons in that a user inserts the spoon into a container of baby food (e.g., ajar 81 as shown in FIGS. 6-8, a plastic tub 91 as shown in FIG. 9, or another suitable container), gathers food into the bowl 25, removes the spoon from the container, and feeds the food in the bowl to the baby. However, the relatively straight front edge 33 and side edges 31 of the bowl 25 make it easier to gather food into the bowl. For example, the front edge 31 of the bowl 25 can be used to wipe food from the bottom or side of the container, clearing a relatively large swath of food in just one swipe because of the relatively wide width W2 of the bowl at the front edge. Likewise, the side edges 31 of the bowl 25 can be used to wipe food from the side of the container. Further, the front edge 33 and one of the side edges 31 of the bowl 25 are configured to conveniently reach the corner 45 formed therebetween relatively far into the bottom corner of the container while the bowl simultaneously squeegees food from the bottom and side of the container. Meanwhile, the curvature of the handle 23 makes it easier to manipulate the bowl 25 to gather food from the container into the bowl because there is more clearance for the handle to pass through the opening. Likewise, it is easier to keep the handle clean because the ample clearance for the handle to pass through the opening makes it less likely that any food residue that may be at the opening of the container will get on the handle.

Both the front edge and the side edge of the bowl facilitate efficiently wiping food from the baby's face during feeding as shown in FIGS. 8 and 9.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A baby spoon comprising:
an elongate handle;
a bowl connected to the handle and having laterally spaced side edges, a back edge extending generally transversely between the side edges, and front edge longitudinally spaced from the back edge and extending transversely between the side edges of the bowl, said front edge of the bowl having a forward most extent of the bowl and also having a smallest radius of curvature of not less than about 0.75 inches, the spacing between the side edges defining a width of the bowl including a maximum width of the bowl, the maximum width of the bowl being spaced longitudinally from the forward most extent of the bowl a distance of no more than about 0.75 inches, the width of the bowl decreasing from the maximum width forward to the front edge of the bowl.

2. The baby spoon set forth in claim 1 wherein the front edge of the bowl has a smallest radius of curvature of not less than about 1.0 inch.

3. The baby spoon set forth in claim 2 wherein the front edge of the bowl has a smallest radius of curvature of not less than about 1.35 inches.

4. The baby spoon set forth in claim 1 wherein the side edges of the bowl and the front edge of the bowl converge at a pair of comers spaced transversely from each other.

5. The baby spoon set forth in claim 1 wherein the bowl has a length of no more than about 2.0 inches.

6. The baby spoon set forth in claim 1 wherein the bowl has a maximum width of no more than about 1.5 inches.

7. The baby spoon set forth in claim 1 wherein the width of the bowl decreases from the maximum width of the bowl rearward to the back edge of the bowl, the maximum width of the bowl being nearer to the front edge of the bowl that to the back edge of the bowl.

8. The baby spoon set forth in claim 7 wherein a distance between said maximum width of the bowl and the forward most extent of the bowl at the front edge thereof is no more than about two-thirds of a distance between said maximum width of the bowl and the back edge of the bowl.

9. The baby spoon set forth in claim 1 wherein the maximum width of the bowl is spaced longitudinally from the forward most extent of the bowl a distance of no more than about 0.5 inches.

10. The baby spoon set forth in claim 1 wherein the bowl has a concavity formed therein for holding food in the bowl, said concavity extending lengthwise from generally adjacent the back edge of the bowl to generally adjacent the front edge of the bowl and being arcuate along substantially its entire length.

11. The baby spoon set forth in claim 1 wherein the front edge of the bowl has a width, a ratio of the width of the front edge of the bowl to the maximum width of the bowl being at least about 0.75.

12. The baby spoon set forth in claim 1 wherein the handle is connected to the back edge of the bowl, the front edge and back edge together defining a plane, the handle being curved so that a portion of the handle is offset from said plane, the handle having an inflection point at a location spaced from the forward most extent of the spoon a distance in the range of about 1.75 inches to about 2.25 inches.

13. A baby spoon comprising:
an elongate handle;
a bowl connected to the handle and having laterally spaced side edges, a back edge extending generally transversely between the side edges, and a front edge longitudinally spaced from the back edge and extending transversely between the side edges of the bowl, said front edge of the bowl having a forward most extent of the bowl and further having a smallest radius of curvature of not less than about 0.75 inches, the bowl having a length from the back edge to the front edge of the bowl of no more than about two inches, the spacing between the side edges defining a width of the bowl including a maximum width of the bowl, the width of the bowl decreasing from the maximum width forward to the front edge of the bowl and rearward to the back edge of the bowl, the maximum width of the bowl being nearer to the front edge of the bowl than to the back edge of the bowl.

14. The baby spoon set forth in claim 13 wherein the front edge of the bowl has a smallest radius of curvature of not less than about 1.0 inch.

15. The baby spoon set forth in claim 14 wherein the front edge of the bowl has a smallest radius of curvature of not less than about 1.35 inches.

16. The baby spoon set forth in claim 13 wherein the side edges of the bowl and the front edge of the bowl converge at a pair of comers spaced transversely from each other.

17. The baby spoon set forth in claim 13 wherein the bowl has a maximum width of no more than about 1.5 inches.

18. The baby spoon set forth in claim 13 wherein a distance between said maximum width of the bowl and the forward most extent of the bowl at the front edge thereof is no more than about two-thirds of a distance between said maximum width of the bowl and the back edge of the bowl.

19. The baby spoon set forth in claim 13 wherein the bowl has a concavity formed therein for holding food in the bowl, said concavity extending lengthwise from generally adjacent the back edge of the bowl to generally adjacent the front edge of the bowl and being arcuate along substantially the entire length of the concavity.

20. The baby spoon set forth in claim 13 wherein the front edge of the bowl has a width, a ratio of the width of the front edge of the bowl to the maximum width of the bowl being at least about 0.75.
